(19) United States
(12) Patent Application Publication
(10) Pub. No.: US 2013/0214994 A1
(43) Pub. Date: Aug. 22, 2013

(54) METHOD OF CONTROLLING MULTIPLE DISPLAYS

(71) Applicants: Munetaka Tsuda, Minami-ku (JP); Yasuto Kakimoto, Minami-ku (JP)

(72) Inventors: Munetaka Tsuda, Minami-ku (JP); Yasuto Kakimoto, Minami-ku (JP)

(73) Assignee: NINTENDO CO., LTD., Kyoto (JP)

(21) Appl. No.: 13/474,299

(22) Filed: May 17, 2012

(30) Foreign Application Priority Data
Feb. 21, 2012 (JP) 2012-035028

(51) Int. Cl. G09G 5/00

(52) U.S. Cl. 345/1.1

(57) ABSTRACT

An information-processing system includes: a first display; a second display; a first display controller that causes the first display and the second display to display respective images based on identical content; and a second display controller that, when a predetermined condition is met, conceals at least part of the image displayed on the second display.

### CROSS-REFERENCE TO RELATED APPLICATIONS

This application is based on and claims priority under 35 U.S.C. 119 from Japanese Patent Application No. 2012-035028, which was filed on Feb. 21, 2012.

### TECHNICAL FIELD

The present invention relates to technology for displaying an image on multiple displays.

### BACKGROUND ART

A technology for displaying an image captured by a camera-equipped mobile phone on a large-screen television using wireless communication is known. With this technology, when an image captured by a camera-equipped mobile phone is to be viewed with family members or friends, for example, the image can be viewed more easily than in a case where the image is displayed on the camera-equipped mobile phone. Further, multiple screens as described in the foregoing may be used in such a manner that the user of the camera-equipped mobile phone performs operations while viewing the screen of the mobile phone, and the other users view images displayed on a large-screen television.

### SUMMARY

In an aspect of the present invention, there is provided an information-processing system including: a first display; a second display; a first display controller that causes the first display and the second display to display respective images based on identical content; and a second display controller that, when a predetermined condition is met, conceals at least part of the image displayed on the second display.

### BRIEF DESCRIPTION OF THE DRAWINGS

Exemplary embodiments of the present invention will now be described in detail based on the following figures, wherein:

FIG. 1 is a diagram showing a configuration of a display system;

FIG. 2 is a block diagram showing a hardware configuration of a main controller;

FIG. 3 is a block diagram showing a hardware configuration of a main device;

FIG. 4 is a block diagram showing a hardware configuration of a sub-controller;

FIG. 5 is a block diagram showing a principal functional configuration of the main device;

FIGS. 6A and 6B are diagrams showing examples of image;

FIGS. 7A and 7B are diagrams showing exemplary displays in which an image is concealed;

FIG. 8 is a flowchart showing a display control process;

FIG. 9 is a diagram showing an example of notification information;

FIGS. 10A and 10BB are diagrams showing examples of concealment image; and

FIG. 11 is a flowchart showing a display control process.

### DETAILED DESCRIPTION

### First Exemplary Embodiment

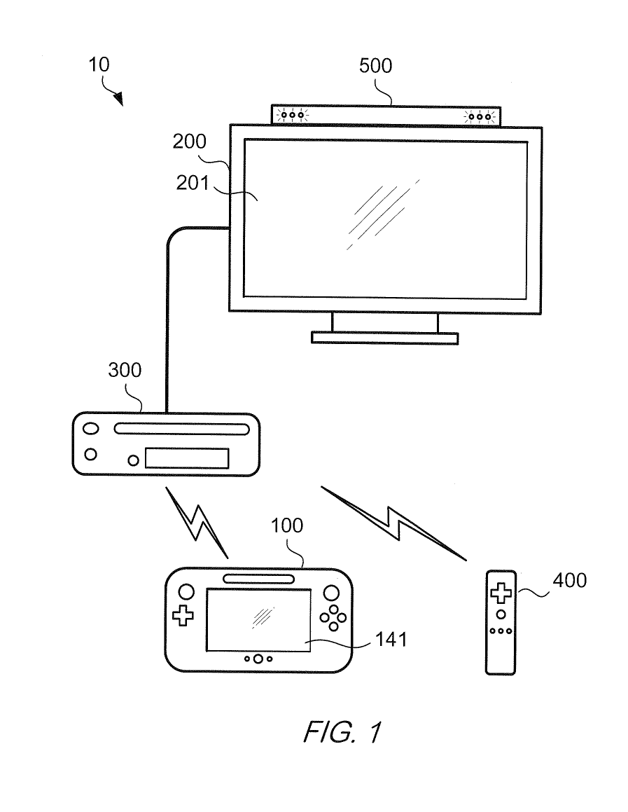

FIG. 1 is a diagram showing a configuration of display system 10, which is an exemplary embodiment of the present invention. Display system 10 is a system for displaying a variety of images in accordance with operations performed by a user. An image displayed in display system 10 is, for example, an image (still image or moving image) of a game or a webpage, but may be another image.

Display system 10 is configured to include main controller 100, monitor 200, main device 300, sub-controller 400, and light-emitting device 500. It is to be noted, however, that display system 10 may include multiple sub-controllers 400.

In this exemplary embodiment, it is assumed that there are multiple (two or more) users. One user operates main controller 100, and another user operates sub-controller 400. In the following description, the user who operates main controller 100 will be referred to as a “main user,” while the other user(s) will be referred to as a “viewer(s),” as necessary. A “viewer” may refer not only to a user who operates sub-controller 400, but also to a user who only views monitor 200 without performing an operation.

Main controller 100 is a terminal on which an image is displayed, and is held by a main user to perform various operations. Main controller 100 herein is a handheld or portable display that has display region 141 and is to be held and operated by a main user. It is to be noted that main controller 100 not only presents information visually by displaying images, but also may present audible or tactile information by using sound or vibration.

Monitor 200 is a device for displaying an image, and may be, for example, a television set for receiving a television broadcast. In this explanation, monitor 200 is a stationary-type display. It is to be noted that monitor 200 does not have to have a function of receiving a television broadcast, and may be a display of a personal computer, or the like. It is assumed that monitor 200 has display region 201 having a larger size than display region 141 of main controller 100, though display region 201 may be the same size as or smaller than display region 141 of main controller 100.

Main device 300 is an information-processing device for controlling operation of main controller 100 and monitor 200. Main device 300 is connected to each of main controller 100 and monitor 200 via wired or wireless communication. It is assumed here that main device 300 conducts wireless communication with main controller 100 and conducts wired communication with monitor 200, though the communication may be performed in another manner.

Sub-controller 400 is a terminal to be held by a viewer to perform various operations, and corresponds to an “operation device” of the present invention. Sub-controller 400 is used to designate a position in display region 201. Sub-controller 400 has an appearance and functions different from those of main controller 100, and in this exemplary embodiment, sub-controller 400 does not have a function of displaying an image. It is preferred that sub-controller 400 has a rod-like shape and is of such a size that it can be held in one hand so that a user can designate a position in display region 201 with ease, though the shape of sub-controller 400 is not limited to such a shape.

Light-emitting device 500 is a device for emitting light that can be detected by sub-controller 400. Preferably, the light emitted from light-emitting device 500 is light that cannot be perceived by a user (or that is hard for a user to perceive), such as infrared light. Light-emitting device 500 includes multiple light sources such as LEDs (Light Emitting Diodes) at different positions (e.g., at left and right end portions). Light-emitting device 500 is disposed at a predetermined position such as at a lower part or an upper part of monitor 200 in such a manner that the relative positional relationship between light-emitting device 500 and display region 201 of monitor 200 does not change.

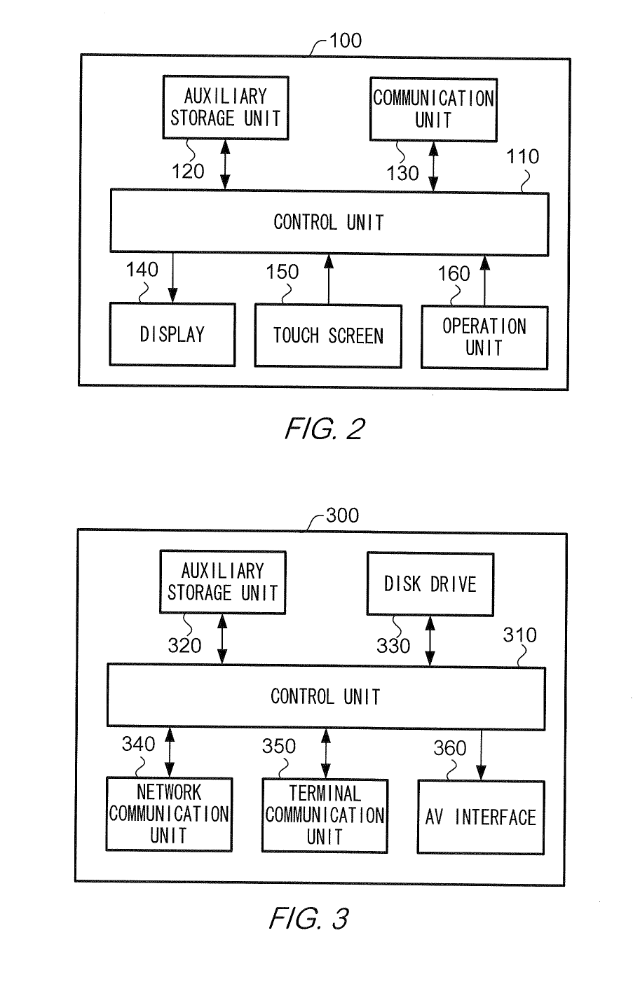

FIG. 2 is a block diagram showing a hardware configuration of main controller 100. Main controller 100 includes control unit 110, auxiliary storage unit 120, communication unit 130, display 140, touch screen 150, and operation unit 160.

Control unit 110 is a means for controlling operations of various units of main controller 100. Control unit 110 includes a processing device such as a CPU (Central Processing Unit), a memory serving as a main memory device, an input/output interface for communicating information with various units of main controller 100, and so on, and executes a program(s) to control display of images or data transmission and reception to and from main device 300.

Auxiliary storage unit 120 is a means for storing data used by control unit 110. Auxiliary storage unit 120 is a flash memory, for example. It is to be noted that auxiliary storage unit 120 may be configured to include a detachable storage medium such as a so-called memory card.

Communication unit 130 is a means for communicating with main device 300. Communication unit 130 includes an antenna or the like for communicating with main device 300 wirelessly.

Display 140 is a means for displaying an image. Display 140 includes a display panel having pixels formed by liquid crystal elements or organic EL (electroluminescence) elements, and a drive circuit for driving the display panel, and displays, in display region 141, an image in accordance with image data provided from control unit 110.

Touch screen 150 is a means for receiving an operation performed by a main user, and generating and supplying coordinate information that represents a position in display region 141. Touch screen 150 includes a sensor disposed to overlap display region 141, and a control circuit for generating coordinate information representing a position detected by the sensor and providing the coordinate information to control unit 110. Touch screen 150 may be of resistive type, or may be of another type such as capacitive type.

Touch screen 150 provides software keys in cooperation with display 140. A software key is a key that is provided in display region 141 by a software process. Unlike a hardware key, the position of a software key is changeable, and display/hiding of a software key can be switched.

Operation unit 160 is another means for receiving an operation performed by a main user. Operation unit 160 includes hardware keys that can be pressed and switches, and provides control unit 110 with operation information (e.g., information relating to each key, indicating whether the key is pressed) in accordance with an operation performed by a user. It is to be noted here that a hardware key is a key provided at a predetermined position of main controller 100, and may also be referred to as a physical key.

It is also to be noted that an “operation unit” of the present invention may be embodied as either touch screen 150 or operation unit 160.

FIG. 3 is a block diagram showing a hardware configuration of main device 300. Main device 300 includes control unit 310, auxiliary storage unit 320, disk drive 330, network communication unit 340, terminal communication unit 350, and AV (Audio and Visual) interface 360.

Control unit 310 is a means for controlling operations of various units of main device 300, and corresponds to a “computer” in the present invention. Control unit 110 includes a processing device such as a CPU, a GPU (Graphics Processing Unit), a DSP (Digital Signal Processor) or the like, a memory serving as a main memory device or a VRAM (Video Random Access Memory), an input/output interface for communicating information with various units of main device 300, and so on, and executes a program(s) to control generation of image data to be transmitted to main controller 100 and monitor 200. The programs that can be executed by control unit 310 include a game program, a browser program for browsing web pages, and so on, such programs being described later.

Auxiliary storage unit 320 is a means for storing data used by control unit 310. Auxiliary storage unit 320 is a flash memory or a hard disk, for example, but may include a detachable storage medium such as a memory card. Auxiliary storage unit 320 is capable of storing programs to be executed by control unit 310 and data acquired via network communication unit 340 or terminal communication unit 350.

Disk drive 330 is a means for reading data stored in an optical disk or other optical storage medium. The optical disk may store data necessary for playing a game, such as a game program, for example. It is to be noted that disk drive 330 may be configured to read data stored in another storage medium such as a magneto-optical disk or a semiconductor memory.

Network communication unit 340 is a means for communicating via a communication network such as the Internet. The communication performed by network communication unit 340 may be wired or wireless communication. Network communication unit 340 receives data from an external server device or transmits data thereto in accordance with instructions from control unit 310.

Terminal communication unit 350 is a means for communicating with main controller 100 and sub-controller 400. The wireless communication performed by terminal communication unit 350 may utilize any communication technology such as Wi-Fi, Bluetooth, or infrared communication. The communication technology used when terminal communication unit 350 communicates with main controller 100 may be different from or the same as that used when terminal communication unit 350 communicates with sub-controller 400.

AV interface 360 is a means for supplying to monitor 200 image data, sound data, or the like. AV interface 360 includes one or more interfaces such as an HDMI (High-Definition Multimedia Interface) terminal or the like.

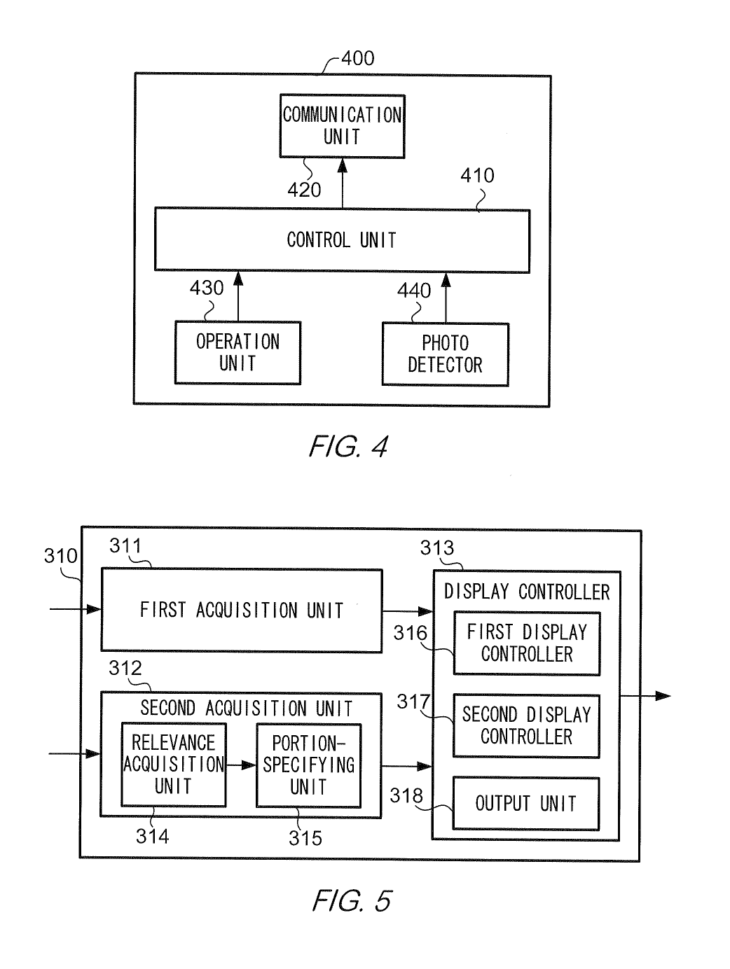

FIG. 4 is a block diagram showing a hardware configuration of sub-controller 400. Sub-controller 400 includes control unit 410, communication unit 420, operation unit 430, and photo detector 440.

Control unit 410 is a means for controlling operations of various units of sub-controller 400. Control unit 410 includes a processing device such as a microcontroller, and a memory, and controls data transmission. Communication unit 420 is a means for communicating with main device 300, and includes an antenna or the like. Operation unit 430 is a means for receiving an operation performed by a viewer, and includes hardware keys with which a viewer performs predetermined operations.

Photo detector 440 includes a light sensor or other imaging devices for detecting light emitted from light-emitting device 500, and an image-processing circuit for calculating coordinate information based on the light detected by the light sensor. Photo detector 440 specifies a position in display region 201, indicated by a viewer using sub-controller 400, from multiple positions of light detected by the light sensor, and generates coordinate information representing the indicated position. To achieve this, the light sensor of photo detector 440 is disposed at an end of sub-controller 400 and on a side caused to face monitor 200 by a viewer. Photo detector 440 corresponds to a “first specifying unit” of the present invention.

FIG. 5 is a block diagram showing a principal functional configuration of main device 300. As a means for enabling display of images on main controller 100 and monitor 200, main device 300 includes first acquisition unit 311, second acquisition unit 312, and display control unit 313. The functions of these units are realized by execution of one or more programs by control unit 310 of main device 300. Namely, the functions of these units are realized by a software process(es).

First acquisition unit 311 is a means for acquiring operation information relating to an operation performed by a user. In addition to information provided by operation unit 160, information acquired by first acquisition unit 311 includes coordinate information provided by touch screen 150. First acquisition unit 311 acquires operation information transmitted from main controller 100 via terminal communication unit 350, and identifies an operation performed by a user (main user) indicated by the acquired operation information.

Further, first acquisition unit 311 acquires, as operation information, information such as coordinates which is transmitted from sub-controller 400. In the following description, operation information transmitted from main controller 100 will be referred to as “first operation information,” and operation information transmitted from sub-controller 400 will be referred to as “second information,” as appropriate. Namely, first operation information is operation information relating to an operation performed by a main user, and second operation information is operation information relating to an operation performed by a viewer.

Second acquisition unit 312 is a means for acquiring a content necessary for displaying an image. A content herein includes data representing characters and/or images (still images or moving images). For example, a content for displaying a webpage includes a style sheet, image data, script, and so on, in addition to data of the webpage itself, which is written in Markup Language such as HTML (HyperText Markup Language).

More specifically, second acquisition unit 312 includes relevance acquisition unit 314 and portion-specifying unit 315. Relevance acquisition unit 314 is a means for acquiring information relevant to the acquired content. Relevant information may be specific data included in the content, or data associated with or allocated to the content. For example, in a case where the content is for displaying a webpage, a tag and a URL (Uniform Resource Locator) included in the content may correspond to relevant information. Portion-specifying unit 315 is a means for specifying a portion of the content based on the relevant information acquired by relevance acquisition unit 314. Portion-specifying unit 315 corresponds to a “second specifying unit” of the present invention.

Display control unit 313 is a means for controlling display of an image. Display control unit 313 causes main controller 100 and monitor 200 to display an image based on content acquired by second acquisition unit 312. Namely, display control unit 313 functions both as a means for causing main controller 100 to display an image and as a means for causing monitor 200 to display an image. Display control unit 313 generates necessary image data, and transmits the image data via terminal communication unit 350 and AV interface 360 to control display of images on main controller 100 and monitor 200.

More specifically, display control unit 313 includes first display controller 316, second display controller 317, and output unit 318. First display controller 316 is a means for causing images based on identical content to be displayed in display region 141 of main controller 100 and in display region 201 of monitor 200. It is to be noted that the images caused to be displayed in display region 141 and display region 201 by first display controller 316 are only required to be based on identical content, and do not have to be identical images. It is only necessary that these images can represent identical content, and the images may differ with regard to, for example, size, resolution, aspect ratio, color (or number of gradations), layout, etc. Further, it is possible to display a menu bar and a tool bar in display region 141 for use by a main user when performing an operation, while not displaying these images in display region 201.

Second display controller 317 is a means for controlling concealment of an image that is caused to be displayed on monitor 200 by first display controller 316. When a predetermined condition is met in a state where images based on identical content are displayed in display region 141 (namely, on main controller 100) and in display region 201 (namely, on monitor 200) under control of first display controller 316, second display controller 317 conceals the image displayed in display region 201. Specifically, second display controller 317 controls display of images such that viewing of an image on monitor 200 is obstructed while viewing of an image on main controller 100 is not. Further, when a predetermined condition is met in a state where an image displayed in display region 201 is concealed, second display controller 317 terminates the concealment.

Concealment performed by second display controller 317 may be applied on an entirety of an image based on a content, or may be applied on only a part of the image. Concealment here not only means completely preventing viewing of an image, but also may mean making viewing of an image less easy. Concealment performed by second display controller 317 may be achieved by displaying a particular image (hereinafter, “concealment image”) which is at least a partial replacement of an image based on a content, such that the concealment image overlaps the image based on a content, or may be achieved by causing a part or an entirety of an image based on a content not to be displayed.

Further, concealment performed by second display controller 317 may be carried out in accordance with an operation performed by a main user, or may be carried out in accordance with relevant information. Thus, the condition for performing of concealment by second display controller 317 may be, for example, reception of a user operation, or acquisition of relevant information. Further, in a case where concealment performed by second display controller 317 is applied on a part of an image based on a content, control may be conducted such that at least a portion specified by portion-specifying unit 315 is concealed.

In the following description, to distinguish from a concealment image, an image based on a content will be referred simply to as an “image.” Thus, first display controller 316 is a means for causing main controller 100 and monitor 200 to display images, and second display controller 317 is a means for concealing at least part of an image displayed on monitor 200.

Output unit 318 is a means for notifying a main user when it is possible for second display controller 317 to perform concealment. Output unit 318 achieves the notification by outputting notification information indicating that such concealment is possible. For example, notification information is visualized as a dialog box or as a predetermined icon, and is notified visually to a main user.

The foregoing is a description of the configuration of display system 10. In this configuration, main device 300 causes display images to be displayed on main controller 100 and monitor 200. In this state, a main user views the image displayed in display region 141 of main controller 100, while a viewer(s) views the image displayed in display region 201 of monitor 200. As is described in the foregoing, the images displayed on main controller 100 and monitor 200 are images based on identical content; thus, a user can obtain the same information by viewing either image.

When a predetermined condition is met, main device 300 is capable of concealing an image displayed on monitor 200. Concealment of an image is performed mainly when it is desired that only a main user can view the image and viewers cannot view (at least part of) the image. A case where an image should be concealed may be, for example, a case where a main user inputs personal information such as an ID or a password on a webpage, or a case where, in a presentation or a slideshow, a main user performs an operation to select an image to be displayed next. Use of concealment of an image is not limited to such cases, and concealment of an image may be performed for a recreational purpose.

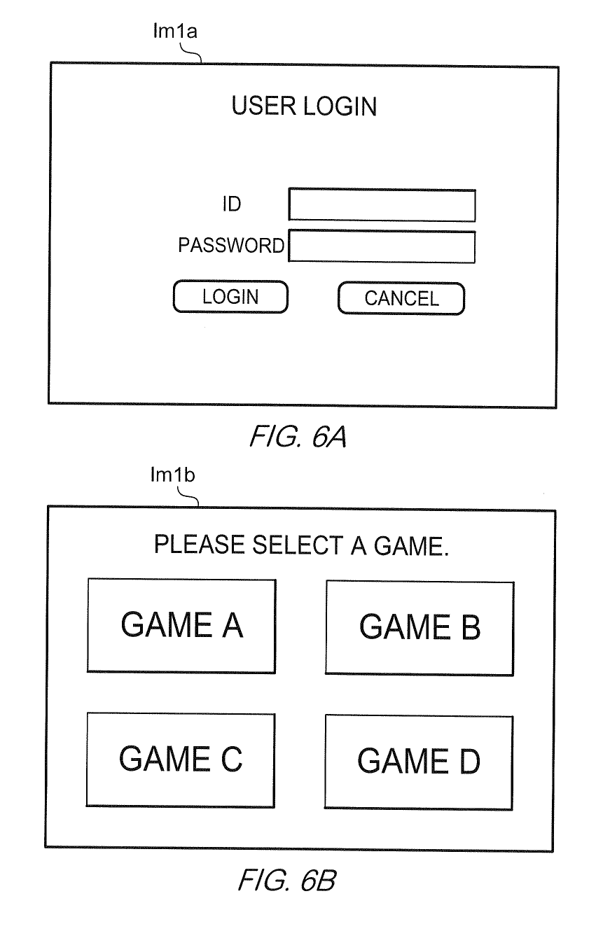

FIG. 6 is a diagram showing an example of an image. Display image Im1a in FIG. 6A represents a login screen for input of an ID and a password, and display image Im1b in FIG. 6B represents another screen to be displayed after input of information in the login screen. Display image Im1a and display image Im2b are displayed in display region 141 of main controller 100 in this order.

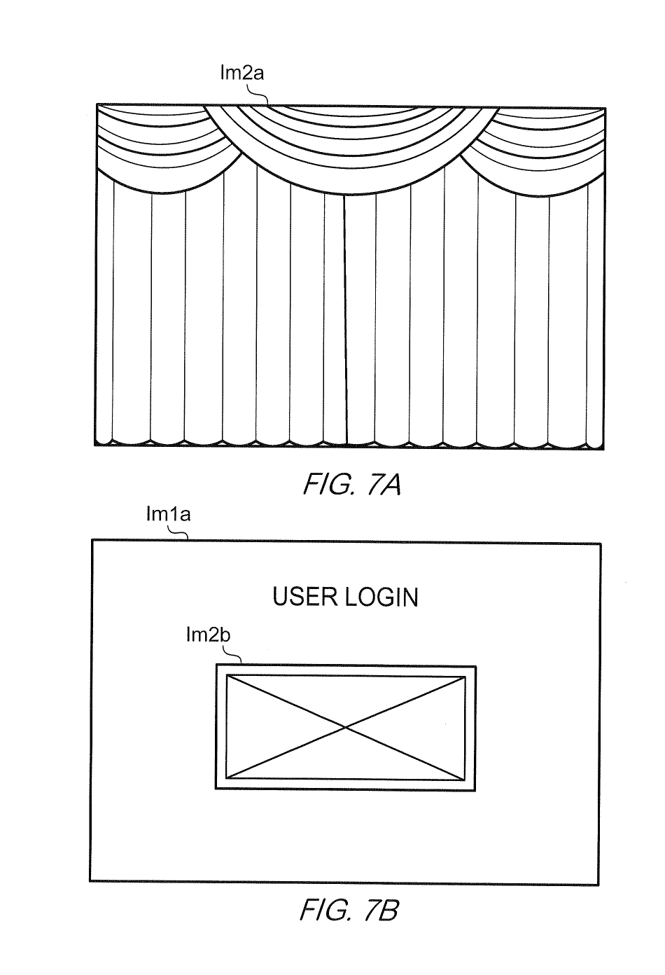

FIG. 7 is a diagram showing an exemplary display in which an image is concealed. FIG. 7A shows concealment image Im2a that covers and conceals all of display image, while FIG. 7B shows concealment image Im2b that conceals a part of display image Im1a. Whether all or a part of an image should be concealed may be predetermined or may be determined by a user operation. A concealment image may be any image so long as it has a visual effect that decreases visibility of an image.

For example, concealment image Im2a may be an image representing a fabric such as a curtain (a drop curtain). Concealment image Im2a may be an image that completely prevents viewing of an image, though it may include, at least partially, an image formed by applying image-processing on an image, such as alpha-blending, blurring, or mosaicing (pixelization), etc. Further, concealment image Im2b may be any image, so long as it can conceal a textbox or the like in the login screen. For example, concealment image Im2b may be an image including a character of a game or the like. Furthermore, each of concealment images Im2a and Im2b does not have to be a still image, and may have a varying mode of display. For example, concealment image Im2a may be an image that presents animation display representing a fluttering curtain, or may be an image representing an animated character of a game or the like that appears at a predetermined position and moves around.

In this example, a main user, who uses main controller 100, can view display image Im1a, and, after entering an ID and other information, can view display image Im1b. Namely, control unit 310 can change an image to be displayed on main controller 100. On the other hand, viewers, who can view images on monitor 200, view either concealment image Im2a or Im2b, instead of or subsequent to viewing display image Im1a, and then, view display image Im1b. Thus, control unit 310 does not have to perform concealment of display image Im1a on monitor 200 from the beginning, and may start performing concealment at a certain timing after display image Im1a has been displayed (for example, at a timing when inputting of information such as an ID is started).

The above-described manner of display enables a main user to perform an operation such as inputting of an ID or the like, or screen changing, while concealing information that should be hidden from viewers, so that viewing of such information is obstructed. Thus, a main user can prevent an image that is displayed for preparatory purposes (in other words, an image that need not be shown to viewers) from being seen by viewers, and allow only an image that need be shown to be viewed by viewers, whereby the image has a strong impact on viewers. In addition, a main user can change the image while concealment is being performed in display region 201 (i.e., during a period from the start to the end of concealment), thereby preventing viewers from knowing when the image is changed or seeing frequent change of the image that may take place when a main user is trying to determine which image should be shown next.

Further, by adopting display control as described in this exemplary embodiment, in a case where multiple thumbnails of still pictures and/or moving pictures are displayed so that one of the thumbnails can be selected to display an original image of the selected thumbnail (namely, an enlarged image of the selected thumbnail), it is possible to prevent viewers from seeing operations performed by a main user trying to determine which image should be enlarged. In this case, concealment of the image may be terminated at a timing a thumbnail is selected and a corresponding enlarged image is displayed.

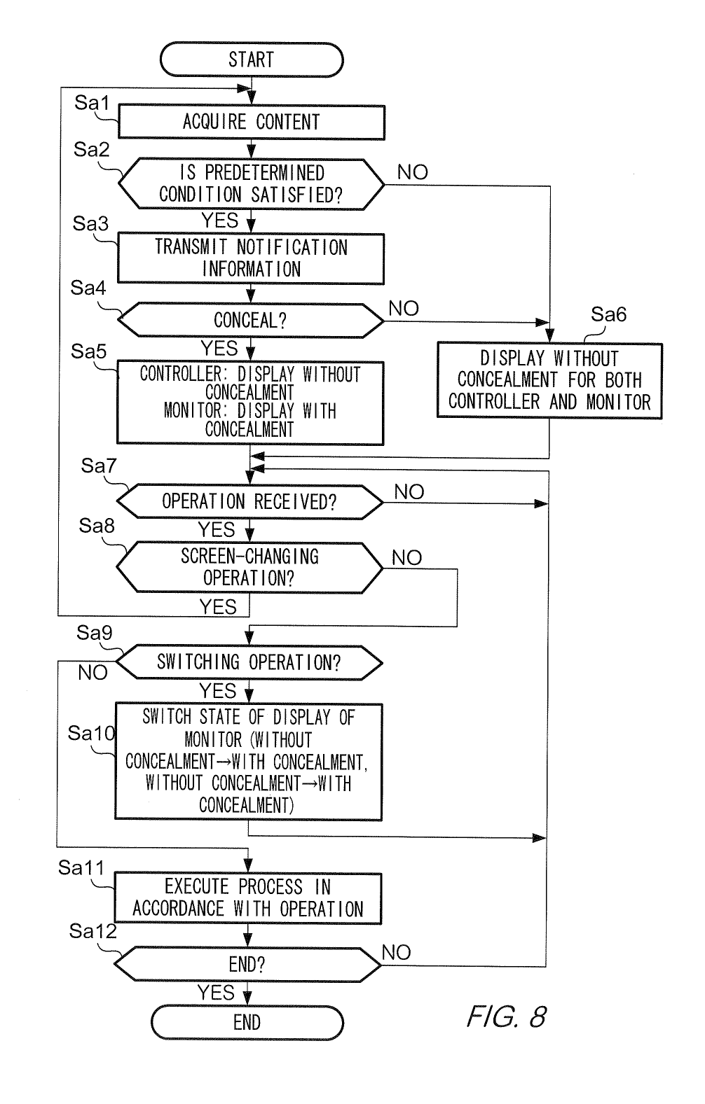

FIG. 8 is a flowchart showing a display control process according to this exemplary embodiment. The display control process shown in this drawing is executed by main device 300. Main device 300 receives operation information (first operation information) from main controller 100, and transmits image data to main controller 100 and monitor 200 to enable them to control images displayed in display regions 141 and 201. It is assumed here that a “content” includes a variety of data for displaying a webpage. Further, sub-controller 400 is not used in this display control process, though sub-controller 400 is used in a second exemplary embodiment, to be described later.

First, control unit 310 of main device 300 acquires a content (step Sa1). Control unit 310 typically acquires a content from an external server device, though in a case where a content is stored in auxiliary storage unit 310 serving as a cache, control unit 310 may acquire the content stored in auxiliary storage unit 320. Thus, a content is not limited to that acquired from outside of main device 300.

Next, control unit 310 determines whether the acquired content satisfies a predetermined condition (step Sa2). For example, control unit 310 may determine whether a specific string of characters is contained in HTML data of the content. Such a specific string of characters may be, for example, a tag indicating a form element (<form>, </form>), or a tag indicating an input element (<input>), an attribute of which is designated as “text area” or “password.” Further, control unit 310 may determine whether a file name of image data or metadata embedded in image data satisfies a predetermined condition. Each of the aforementioned string of characters and data may correspond to “relevant information” of the present invention.

Alternatively, control unit 310 may use, as relevant information, a URL or a communication protocol relating to downloading of a content. For example, control unit 310 may determine that a predetermined condition is met when a content is received via HTTPS (Hypertext Transfer Protocol over Secure Socket Layer) instead of HTTP (Hypertext Transfer Protocol). This is because a content communicated via HTTPS is more likely to include information that should be hidden from a third party than a content communicated via HTTP. This determination can be made also based on a string of characters in a URL (namely, based on whether a URL begins with “http:” or “https:”).

If the acquired content satisfies a predetermined condition (Sa2: YES), control unit 310 transmits notification information to main controller 100 that concealment of an image is possible if a predetermined operation is performed (step Sa3). In this exemplary embodiment, notification information is transmitted as image data.

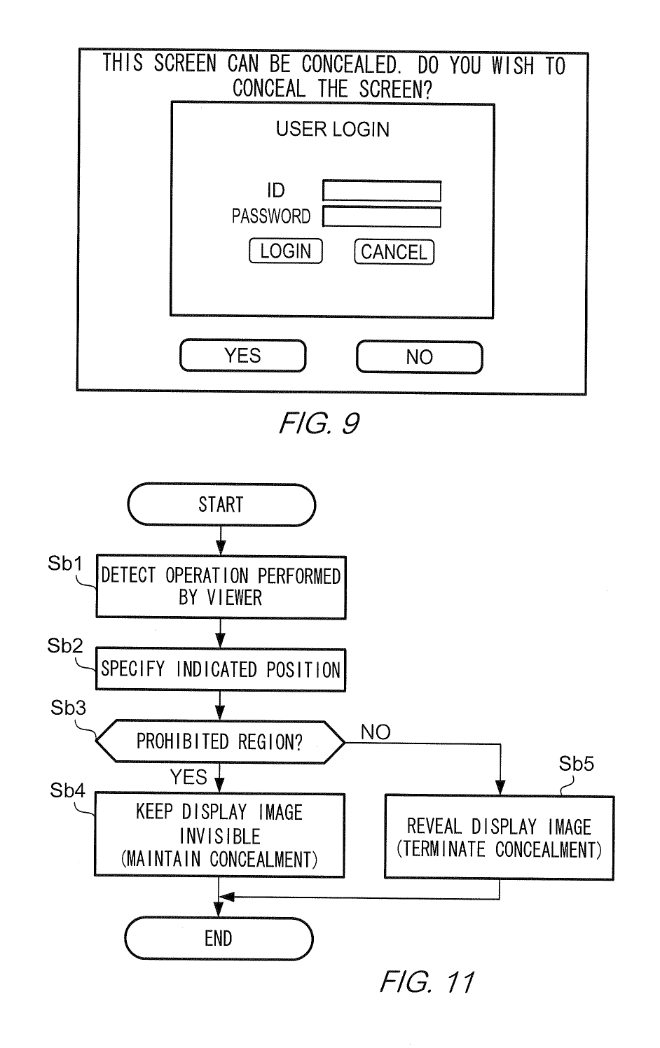

FIG. 9 is a diagram showing an example of notification information. In this example, main controller 100 displays an image in accordance with the acquired content, together with a message that the image can be concealed, and receives an operation performed by a main user. At this time, main controller 100 may receive an operation performed by the main user specifying a portion of the image to be concealed. It is to be noted that the screen shown in FIG. 9 is not displayed on monitor 200.

After conducting notification, control unit 310 assesses the operation performed by the main user (step Sa4), and executes a process in accordance with the operation.

In a case where the main user selects concealment of an image (Sa4: YES), control unit 310 causes main controller 100 to display an image, while causing monitor 200 to display an image at least part of which is concealed (see FIG. 7) (step Sa5). In a case where a part of an image is to be concealed, control unit 310 specifies an element(s) of the image to be concealed (form, text area, frame, or the like) based on the relevant information. For example, in a case where a tag indicating a text area is used as the relevant information, control unit 310 specifies a portion in the image corresponding to the text area, and conceals the portion.

On the other hand, in a case where the main user selects not to conceal an image (Sa4: NO), control unit 310 causes both main controller 100 and monitor 200 to display respective images based on the identical content, without concealment of the image on monitor 200 (step Sa6). It is to be noted that in a case where the acquired content does not satisfy a predetermined condition (Sa2: NO), namely, when there is no need for concealment, control unit 310 also performs the process of step Sa6 to cause both main controller 100 and monitor 200 to display respective images.

After causing images to be displayed, control unit 310 waits for an operation performed by the main user. It is assumed here that an operation performed by the main user is one of the following three types of operations: a “screen-changing operation” for changing the screen to display a new page; a “switching operation” for switching between display of an image with concealment and display of an image without concealment; and “another operation,” which is neither a screen-changing operation nor a switching operation. Control unit 310 determines whether such an operation is performed (step Sa7), and if no operation performed by the main user is received (Sa7: NO), maintains the current state of display.

On the other hand, if an operation performed by the main user is received (Sa7: YES), control unit 310 determines whether the operation is a screen-changing operation (step Sa8). If the operation is a screen-changing operation (Sa8: YES), control unit 310 repeats the aforementioned process starting with step Sa1. Namely, control unit 310 acquires a new content in accordance with the screen-changing operation performed by the main user, and causes an image (display image/concealment image) to be displayed in accordance with the acquired content. If this process is repeated, main controller 100 always displays an image, while an image on monitor 200 is concealed appropriately, as necessary.

In a case where the operation performed by the main user is not a screen-changing operation (Sa8: NO), control unit 310 determines further whether the operation is a switching operation (step Sa9). A switching operation is, for example, pressing of a predetermined key of main controller 100. If the operation performed by the main user is a switching operation (Sa9: YES) control unit 310 switches a state of display of an image (step Sa10). Specifically, if the image is being concealed, control unit 310 terminates concealment, and if the image is not being concealed, control unit 310 conceals at least part of the image. At this time, control unit switches only the state of display of the image on monitor 200, while maintaining the state of display of the image on main controller 100. After switching the state of display of the image, control unit 310 repeats the determination of step Sa7 and the process thereafter.

If the operation performed by the main user is neither a screen-changing operation nor a switching operation, i.e., “another operation” (Sa9: NO), control unit 310 executes a process in accordance with the operation (step Sa11). This process may vary depending on the operation performed by the main user, and thus, detailed explanation thereof is omitted. At this time, if the main user performs an operation for terminating display of an image (Sa12: YES), control unit 310 terminates the process. If the operation performed by the main user is other than the terminating operation (Sa12: NO), control unit 310 repeats the determination of step Sa7 and the process thereafter.

As is described in the foregoing, in display system 10 of the present exemplary embodiment, it is possible, when causing display images based on identical content to be displayed on main controller 100 and monitor 200, to conduct control such that the image on monitor 200 is concealed, without interfering with display on main controller 100. Thus, it is possible to prevent images that should be hidden from viewers from being seen by viewers, while viewing of images and operations performed by the main user is not obstructed. The main user can conceal the image on monitor 200 without turning off the power of monitor 200, and also can conceal the image partially.

It is to be noted that, in this exemplary embodiment, notification that concealment of an image is possible (step Sa3) is not mandatory. Namely, when the acquired content satisfies a predetermined condition, control unit 310 may conceal the image on monitor 200 without notifying the main user, i.e., without receiving an operation performed by the main user (step Sa4).

### Second Exemplary Embodiment

This exemplary embodiment has a similar hardware configuration to that of the aforementioned first exemplary embodiment, but a concrete operation and the like differ. This exemplary embodiment differs from the first exemplary embodiment in a point that, in this exemplary embodiment, a viewer performs an operation using sub-controller 400. Further, this exemplary embodiment also differs from the first exemplary embodiment in a point that in this exemplary embodiment, a manner of concealment of an image can be changed in accordance with an operation performed by a viewer.

For convenience of explanation, it is assumed that concealment in this exemplary embodiment is achieved by a concealment image that covers an entirety of an image, as is shown exemplarily in FIG. 7A. However, this does not mean that concealment in this exemplary embodiment can be achieved only in such a manner.

In this exemplary embodiment, a viewer is allowed to terminate concealment of an image partially. When a concealment image is displayed on monitor 200, by indicating a specific position in display region 201 of monitor 200 by using sub-controller 400, a viewer can change a manner of display of a portion of the concealment image at the indicated position. To enable a viewer to know which position in display region 201 is indicated, main device 300 may control monitor 200 such that an image such as a cursor (or a pointer) is displayed thereon. In this case, a viewer can move the cursor to a desired position and press a predetermined key, thereby terminating concealment of a portion of the image at the desired position.

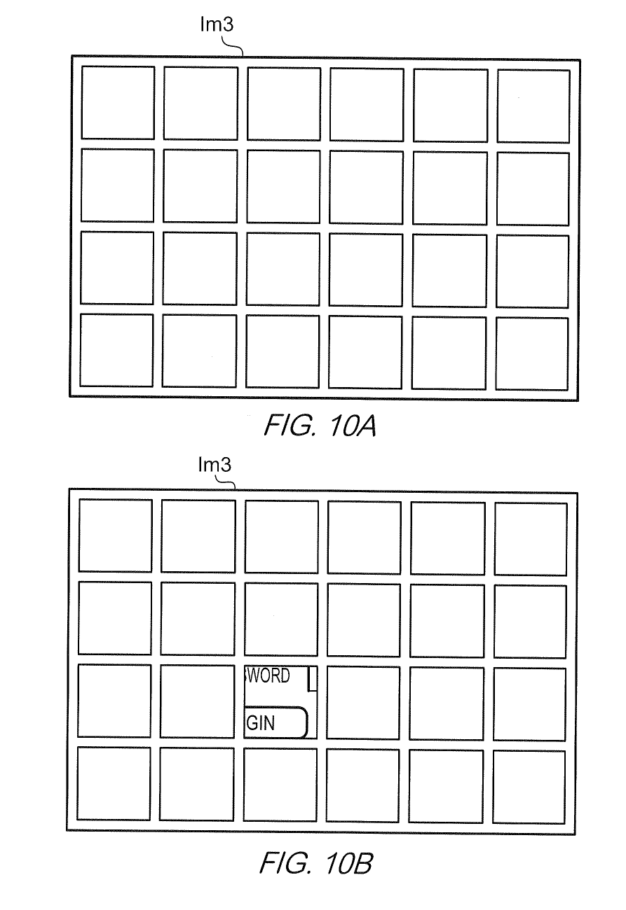

FIG. 10 is a diagram showing an example of a concealment image according to this exemplary embodiment. In FIG. 10A, concealment image Im3 is an image representing multiple (4×6) panels arranged in a grid-like pattern. If a viewer indicates one of these panels, it becomes possible to view (a part of) the image at the indicated position of concealment image Im3, as shown in FIG. 10B. Monitor 200 may achieve this by causing the panel at the indicated position not to be displayed or by displaying an animated image so that the panel at the indicated position is caused to rotate about a center line to reveal the image partially. It is to be noted that, in this case, a viewer may be allowed to view the image for a predetermined time period, or until a viewer performs a predetermined operation for causing the image not to be displayed again.

A concealment image in this exemplary embodiment is not limited to concealment image Im3 shown in FIG. 10, and may be an image representing a fabric or the like. In this case, in response to indication by a viewer, control device 300 may cause monitor 200 to display an animated image such that a hole is formed at a portion (indicated position) of a fabric or an animated image in that a portion (indicated position) of a fabric becomes transparent. The visual effect provided by main device 300 may be arbitrary, so long as it increases visibility of a portion of a concealment image at the indicated position compared to visibility of another portion.

Further, main device 300 may set, in an image, a portion in which termination of concealment in response to a viewer's operation is permitted and a portion in which termination of concealment in response to a viewer's operation is prohibited. In the following description, a portion of an image in which termination of concealment in response to a viewer's operation is prohibited will be referred to as a “prohibited region.” A prohibited region may be set based on the relevant information, or may be set in accordance with an operation performed by a main user. A prohibited region may include a portion that the main user does not want to be viewed by other people or a portion that may cause some inconvenience if seen by a viewer.

FIG. 11 is a flowchart showing a display control process according to this exemplary embodiment. This process is executed, for example, as an interruption process to the display control process of the first exemplary embodiment (see FIG. 8). Upon receipt of an operation performed by a viewer, namely, operation information (second operation information) from sub-controller 400 in a state where a concealment image is displayed, main device 300 executes the following process.

First, control unit 310 of main device 300 acquires second operation information from sub-controller 400, and detects an operation performed by a viewer (step Sb1). The second operation information includes at least coordinate information indicating a portion of display region 201 of monitor 200. It is to be noted that instead of acquiring coordinate information, control unit 310 may calculate coordinate information based on information acquired from sub-controller 400. Based on the coordinate information, control unit 310 specifies a position indicated by a viewer, i.e., an indicated position (step Sb2).

After specifying the indicated position, control unit 310 determines whether the position is in the prohibited region (step Sb3). If the indicated position is in the prohibited region (Sb3: YES), control unit 310 does not terminate concealment by the concealment image, keeping the image invisible (step Sb4). On the other hand, if the indicated position is not in the prohibited region (Sb3: NO), control unit 310 terminates concealment at the indicated position to reveal a portion of the display region (step Sb5).

In a case where no prohibited region is set, the process of steps Sb3 and Sb4 may be omitted. In this case, control unit 310 does not restrict termination of concealment, and causes a portion of an image corresponding to the position indicated by a viewer to be displayed.

Further, instead of keeping the portion of the image corresponding to the indicated image totally invisible, the process of step Sb4 may cause the portion to be displayed only for an instant (i.e., for such a short period of time that it almost cannot be identified by a viewer). Namely, control unit 310 may cause the image to be displayed in step Sb4 in such a manner that the visibility is more limited than in step Sb5. Further, control unit 310 may be configured to receive an operation performed by the main user so that the main user can select a degree of visibility of such limited display.

In this exemplary embodiment, when an image is concealed, a viewer can view a concealed portion. In other words, a viewer can have a “peep” at the concealed display image. In this way, it is possible to impart an entertainment feature when an image is concealed, so that while the main user is preparing for a presentation or a slideshow, for example, viewers do not lose interest. On the other hand, in a case where an image includes a portion that may not be seen by a viewer, it is possible to set a prohibited region, thereby to prevent inadvertent exposure of such a portion.

It is to be noted that instead of the process of terminating concealment at the indicated position to reveal a portion of the image (Sb5), control unit 310 may ease concealment at the indicated position. “Easing of concealment” here means displaying an image with a certain restriction, instead of displaying an image without concealment. Namely, a state in which concealment of an image is eased is a state between a state in which an image is concealed and a state in which an image is not concealed, or a state in which visibility of an image is higher than in a state in which an image is concealed and lower than in a state in which an image is concealed.

### Modifications

Each of the exemplary embodiments described in the foregoing is one embodiment for carrying out the present invention. The present invention is not limited to these exemplary embodiments, and can be carried out in other embodiments, as shown by the following modifications. It is to be noted that multiple modifications may be combined as required in carrying out the invention.

### Modification 1

A first specifying unit of the present invention may be included in main device 300 instead of in sub-controller 400. In this case, sub-controller 400 detects light emitted from light-emitting device 500, and transmits to main device 300 image data representing a result of imaging of the detected light. Main device 300 receives the image data, and specifies an indicated position based on the result of imaging of the light emitted from light-emitting device 500.

### Modification 2

The notification information may be any information for notifying a main user that concealment of an image will be performed in response to a predetermined operation, and does not have to be an image. For example, in a case where main controller 100 is provided with a lamp (indicator) constituted of an LED or the like, it is possible to turn on the lamp to provide notification to the main user. In this case, main device 300 may transmit to main controller 100 an instruction to turn on or flicker the lamp, as the notification information.

Further, the notification information may be an instruction for causing main controller 100 to output a sound (beep or the like), or for causing main controller 100 to vibrate. Thus, the notification based on the notification information is not limited to visual notification.

### Modification 3

The partial termination of concealment of an image may be performed without an operation performed by a viewer. For example, in a case where an image of a curtain as shown in FIG. 7A is displayed as a concealment image, main device 300 may cause an image of a spotlight irradiating a portion of the concealment image to be displayed, to impart to the portion of an image irradiated with the spotlight a visual effect of increased visibility (e.g., a visual effect giving an impression that the other side of the curtain is seen through the curtain). In this case, main device 300 may move the portion irradiated with the spotlight at random or in a shape of figure “8,” without an operation performed by a viewer. In this way, an entertainment feature is imparted when an image is concealed, and viewers will speculate about an image that will be displayed when the concealment image is removed.

It is to be noted that, in this example, if the image includes a prohibited region, main device 300 may control a manner of display of the concealment image such that the visibility of the image is not increased in the prohibited region. For example, main device 300 may control the manner of display such that the spotlight is not irradiated onto the prohibited region, or the visibility of the image in the prohibited region does not increase even if the spotlight is irradiated.

### Modification 4

Concealment of an image may be performed in accordance with a setting made by a user in advance. For example, a user may set a type(s) of image (such as a form element) that, when displayed as an image, requires concealment, or may set a URL or a domain, such that when a content is acquired from the URL or the domain, concealment of an image is performed.

In this case, main device 300 may store the information set by a user in auxiliary storage unit 320 as setting information, and read out the setting information, as necessary. For example, upon acquisition of relevant information, main device 300 reads out setting information to compare the relevant information and the setting information by use of pattern matching, and, if the result of comparison satisfies a predetermined condition, performs concealment of an image.

Main device 300 may store the aforementioned setting information for each user. In this way, in a case where there are multiple main users, it is possible to carry out operations respective to each main user. It is to be noted that, to identify a main user, it is possible to utilize a known verification process using a password or the like.

Further, setting information may be stored in main controller 100 instead of in main device 300. In this case, main device 300 may receive setting information from main controller 100 at an appropriate timing before performing concealment of an image, and store the received setting information in auxiliary storage unit 320 or in a memory of control unit 310.

### Modification 5

The present invention does not have to be carried out in main device 300 or in display system 10 including main device 300, but also can be carried out in an information-processing device (e.g., a so-called tablet terminal) including integrally a configuration corresponding to main device 300 and a configuration corresponding to main controller 100. Alternatively, the present invention may be configured such that part or all of the display control relating to the present invention (namely, control such as that performed by first display controller 316 and second display controller 317) is performed by main controller 100 and monitor 200, or may be configured such that the display control for the displays is performed by each device, whereby a configuration corresponding to main device 300 is omitted. Further, the information-processing device of the present invention does not have to be of a shape to be held with both hands, but may be of such a shape that it is to be held by a single hand, or may be adapted to be placed on a desk or the like when operated. The information-processing device of the present invention does not have to have a game function.

Further, the present invention may be carried out not only as an information-processing device (control device) or a display system as described in the foregoing, but also as an image-displaying method for concealing an image under a predetermined condition or an information-processing program for executing such an image-displaying method. Furthermore, the information-processing program of the present invention may be stored in a storage medium such as an optical disk or a semiconductor memory, or may be downloaded to an information-processing device via a network such as the Internet.

The foregoing description of the embodiments of the present invention is provided for purposes of illustration and description, and is in no way to be taken as either exhaustive or specifically limitative of the present invention; and it will be obvious to those skilled in the art that a wide range of modifications and variations can be applied to the invention described in the exemplified embodiments, with such embodiments having been chosen merely with a view to providing a clear explanation of the principles of the present invention and its range of practical application, thereby to enable others skilled in the art to understand the invention in the context of a variety of embodiments, which can be adopted in the scope of the invention so as to best suit a contemplated use. The scope of the invention is intended to be defined by the claims that follow and equivalents thereof.

What is claimed is:

1. An information-processing system comprising:
a first display;
a second display;
a first display controller that causes the first display and the second display to display respective images based on identical content; and
a second display controller that, when a predetermined condition is met, conceals at least part of the image displayed on the second display.

2. The information-processing system according to claim 1, wherein when the predetermined condition is met, the second display controller conceals at least part of the image displayed on the second display in a state where display of the image on the first display by the first display controller is maintained.

3. The information-processing system according to claim 1, wherein
the first display is a handheld display, and
the second display is a stationary-type display.

4. The information-processing system according to claim 1, wherein when the predetermined condition is met after the image is caused by the first display controller to be displayed on the second display, the second display controller conceals at least part of the image displayed on the second display.

5. The information-processing system according to claim 1, wherein
the first display includes an operation unit that receives an operation performed by a user, and
the second display controller conceals at least part of the image displayed on the second display when a predetermined operation is received by the operation unit.

6. The information-processing system according to claim 5, further comprising:
an acquisition unit that acquires relevant information relating to the content; and
an output unit that, when the relevant information acquired by the acquisition unit satisfies a predetermined condition, outputs notification information for notifying a user that the concealment will be performed by the second display controller in response to a predetermined operation received by the operation unit.

7. The information-processing system according to claim 5, wherein when a predetermined operation is received by the operation unit after at least part of the image is concealed, the second display controller terminates the concealment of the at least part of the image.

8. The information-processing system according to claim 1, wherein
the first display controller changes the images, and
the second display controller conceals at least part of the image displayed on the second display at least during the time that the images are being changed by the display control unit.

9. The information-processing system according to claim 1, wherein the second display controller causes a concealment image for concealing the image to be displayed, and changes a manner of display of the concealment image at a position in a display region of the second display.

10. The information-processing system according to claim 9, wherein the second display controller changes the manner of display of the concealment image such that a part of the image can be viewed.

11. The information-processing system according to claim 9, further comprising:
an operation device that receives an operation performed by a user; and
a first specifying unit that specifies a position in the display region of the second display based on the operation received by the operation device,
wherein the second display controller changes the manner of display of the concealment image at the position specified by the first specifying unit.

12. The information-processing system according to claim 9, wherein the second display controller causes an image having a visual effect of decreasing visibility of the image to be displayed as the concealment image.

13. The information-processing system according to claim 1, wherein the second display controller causes a concealment image having a visual effect of decreasing visibility of the image to be displayed, and changes a manner of display of the concealment image, such that a portion of the concealment image in which visibility of the image is increased moves.

14. The information-processing system according to claim 1, further comprising:
an acquisition unit that acquires relevant information relating to the content; and
a second specifying unit that, based on the relevant information, specifies a portion in the image to be concealed,
wherein the second display controller conceals at least the portion determined by the second determination unit.

15. The information-processing system according to claim 1, further comprising:
a storage unit that stores setting information relating to a user; and
an acquisition unit that acquires relevant information relating to the content,
wherein the second display controller conceals at least part of the image when a result of comparison of the setting information and the relevant information satisfies a predetermined condition.

16. The information-processing system according to claim 1, further comprising an acquisition unit that acquires the content via a communication network,
wherein the second display controller conceals at least part of the image corresponding to the content in a case where a predetermined communication protocol is used when the acquisition unit acquires the content.

17. The information-processing system according to claim 1, further comprising an acquisition unit that acquires the content via a communication network,
wherein the second display controller conceals at least part of the image corresponding to the content in a case where identification information of the content acquired by the acquisition unit is predetermined identification information or in a case where the content includes predetermined data.

18. A control device comprising:
a first display controller that causes a first display and a second display to display respective images based on identical content; and
a second display controller that, when a predetermined condition is met, conceals at least part of the image displayed on the second display.

19. A non-transient storage medium that stores a program for causing a computer to execute:
causing a first display and a second display to display respective images based on identical content; and
when a predetermined condition is met, concealing at least part of the image displayed on the second display.

20. A method of displaying an image, comprising:
causing a first display and a second display to display respective images based on identical content; and
when a predetermined condition is met, concealing at least part of the image displayed on the second display.
